(19) United States
(12) Patent Application Publication
(10) Pub. No.: US 2011/0014256 A1
(43) Pub. Date: Jan. 20, 2011

(54) LONG-LASTING ANTI-MICROBIAL COMPOSITION AND ANTI-MICROBIAL FILM AND SPRAY THEREOF

(76) Inventors: Ling-Ko CHANG, Changhua County (TW); Yu-Ming Wang, Taichung City (TW); Kao-Der Chang, Taichung County (TW); Wen-Hsien Sun, Taoyuan County (TW); Ming-Jyh Chang, Keelung City (TW)

Correspondence Address: BIRCH STEWART KOLASCH & BIRCH, PO BOX 747, FALLS CHURCH, VA, 22040-0747, US

(21) Appl. No.: 12/754,198

(22) Filed: Apr. 5, 2010

(30) Foreign Application Priority Data
Jul. 16, 2009 (TW) 098124047

(51) Int. Cl. A01N 25/00; A01N 59/16; A01N 59/20; A01N 55/02; A01P 1/00

(52) U.S. Cl. 424/405; 424/618; 424/630; 424/646; 514/495; 514/499; 514/502; 424/78.08; 424/78.32; 977/762

(57) ABSTRACT

A long-lasting anti-microbial composition is provided, which includes one or more polymer or oligomer and a plurality of nanowires distributed therein, wherein the nanowires have an aspect ratio of more than 20 and the nanowires form a network-like structure. An anti-microbial film and spray including the composition are also provided.

### CROSS REFERENCE TO RELATED APPLICATIONS

This application claims the benefit of Taiwan Patent Application No. 098124047, filed Jul. 16, 2009.

### BACKGROUND OF THE INVENTION

1. Field of the Invention

The present invention relates to a long-lasting anti-microbial composition, and in particular relates to a long-lasting anti-microbial composition containing nanowires.

2. Description of the Related Art

Due to clean living requirements and effective sanitation, various antimicrobial materials have been developed. Antimicrobial concepts generally refer to inhibition or killing of microorganisms. Currently, antimicrobial agents may be categorized into two groups, organic and inorganic agents. Organic agents are commonly used against bacteria but have many disadvantages, such as poor chemical stability, easy heat decomposition, high evaporation rates, odors and a short-lasting effective period. Inorganic materials kill or inhibit bacteria through use of metal ions, such as Ag, Hg, Cu, Pd, Cr, Ni, Pb, Co, Zn and Fe. The inorganic materials with metal ions have advantages of having good antibacterial properties, having the ability to inhibit various species of bacteria, being safe for humans, and having a long-lasting effective period. The metal ions are known to inhibit or kill bacteria through four pathways: interfering synthesis of cell walls, destroying cell membranes, inhibiting synthesis of proteins and interfering synthesis of nucleic acids.

Among metal ions, Ag ions are the most efficient in inhibiting bacteria development when compared to other metal ions, thereby having better antibacterial effects (Table 1) (Antibacterial Surface Treatment Technologies of Metals, J. L. Huang, et al., Metal Industrial Research and Development Centre, July, 2008).

TABLE 1
Minimum inhibitory concentration (MIC) of metal
ions against bacteria (μg/ml)

| Metal Ions | MIC (μg/ml) |
|---|---|
| Ag | 0.78~6.3 |
| Co, Ni, Al, Zn, Cu, Fe | 100~400 |
| Mn, Sn | 800~1600 |
| Ba, Mg, Ca | >6400 |

It has been disclosed that Ag ions are more efficient against Gram-negative bacteria than Gram-positive bacteria, while Cu ions are more efficient against Gram-positive bacteria than Gram-negative bacteria (Table 2). Since Cu ions are more easily oxidized, antibacterial developments has focused on Ag ions (Antibacterial Surface Treatment Technologies of Metals, J. L. Huang, et al., Metal Industrial Research and Development Centre, July, 2008).

TABLE 2
Minimum inhibitory concentration (MIC) of Ag and
Cu ions against bacteria (μg/ml)

| | MIC of Ag ions | MIC of Cu ions |
|---|---|---|
| Bacteria | (μg/ml) | (μg/ml) |
| E. coli | 0.78 | 400 |
| Pseudomonas aeruginosa | 0.78 | 400 |
| Salmonella | 0.78 | 400 |
| Streptococcus pneumoniae | 0.78 | 400 |
| Staphylococcus aureus | 6.3 | 200 |
| Micrococcus | 0.78 | 400 |
| Corynebacterium | 0.78 | 400 |
| Bacillus subtilis | 1.56 | 200 |

Silver has been widely used, such as water filtering. It has been applied in medicine since the 19th century, such as, in eyewashes, for dressings and for antibiotics. In the 21st century, silver antibacterial products have been developed for application in housekeeping appliances, clothes, medicine, and antibacterial sprays.

Once the size of the antibacterial metal materials becomes nano-structures, the relative surface area of the metal materials increases dramatically, thus leading to more free metal ions which cause antibacterial effects. For instance, silver nanoparticles have a larger surface area than silver bulks or microparticles, and the antibacterial ability can increase about 200 times (Nanotechnology Research Center, Lyu, 2007). Although metal nanoparticles increase inhibition rates, when mixed with a substrate, only the exposed nanoparticles on the surface of the substrate are released by attraction of the electrodes of bacteria. Free nanoparticles contact with bacteria to exhibit antibacterial effects. However, the nanoparticles fixed in the substrate are normally blocked and inhibited from being released to the surface of the substrate, thereby decreasing antibacterial ability and effective time period thereof.

US Patent No. 2006/0068025 discloses a simplified and low-cost microribbon composition. The composition has low optical density. However, when the microribbons and nanowires are in equal amounts, the microribbons release relatively less Ag ions because the surface area of the microribbons is much smaller than that of the nanowires. Thus, the antimicrobial effect of the microribbons is less than that of the nanowires. In addition, when mixed with substrates, the microribbon exposes a smaller surface area, thus reducing the time of antibacterial ability to a shorter effective time period than that of nanowires.

WO 2007/001453 A2 discloses an anti-virus composition comprising noble metal nanoparticles and nanowires, which release more than 80% of silver ions in 60 minutes to 8 hours. However, when contacting air, the nanowires in the reference become nano-crystals and the surfaces become rough. Thus, additional compounds are required to stabilize the nanostructure. Also, the “nanowire” in the reference is defined by fixing Ag nanoparticles onto a surface of a nanowire by chemical coupling or using other compounds. Thus, the method therein hinders silver ions from being released to the surface of a substrate when mixed therein, thereby producing slower and short-lasting antibacterial effect.

In order to solve the difficulties described above, a fast and long-lasting antimicrobial composition is needed.

### BRIEF SUMMARY OF THE INVENTION

The invention provides a long-lasting anti-microbial composition including one or more polymer or oligomer and a plurality of nanowires distributed therein, in which the nanowires have an aspect ratio of more than 20 and form a network-like structure.

The invention also provides an anti-microbial film and an anti-microbial spray including the long-lasting anti-microbial composition.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing the movement of the metal ions in the network-like structure of the invention;

FIG. 2 is a photograph under Scan Electron Microscope (SEM) showing the configuration of the nanowires;

FIG. 3 is a photograph under SEM showing a distribution of the nanowires in polymers;

FIG. 4 shows anti-microbial effects of the composition, in which the circular sectors are test films; and

FIG. 5 shows a long-lasting anti-microbial effect of the composition, in which the squares are test films.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. Any patents, patent applications, and publications cited herein are incorporated by reference.

The invention provides a novel nanowire composition efficiently releasing antimicrobial metal ions with a long-lasting effective time period. The composition comprises nanowires made from antimicrobial metal materials, wherein the nanowires have a specific aspect ratio and one dimensional configuration and are mixed in polymer and/or oligomer substrates. Compared with identical quantities of bulks or microparticles, the nanowires of the invention have larger surface area. The nanowires of the invention construct a network or network-like structure in the substrate, in which the network or network-like structure stores the antimicrobial metal ions inside the substrate free from external influence. When pathogens or microbes are close to the substrate, the antimicrobial metal ions stored in the structure are influenced by the ion potential of the pathogens or microbes and are released to the surface of the substrate though the network or network-like structure. Therefore, the composition of the invention can constantly release the antimicrobial metal ions to inhibit or kill pathogens or microbes. The composition of the invention utilizes nanowires with specific aspect ratio filled in a substrate to increase releasing rate, thereby providing a long-lasting antimicrobial effect.

The “nanowire” herein refers to a nanostructure having an aspect ratio of more than 20, not including 20. The “aspect ratio” herein refers to the ratio of the length of the nanostructure to the diameter of the nanostructure, represented as:

$$Aspect ratio = \frac{length of the nanowires}{diameter of the nanowires} .$$

When the aspect ratio of the nanostructure is close to 1, the configuration of the nanostructure is a nanoparticle. When the aspect ratio is between 2 to 20, the configuration becomes a nanorod. Nanoparticles or nanorods are not included in the invention because they fail to efficiently form a network or network-like structure as described herein.

The nanowires of the invention have an aspect ratio of more than 20 and are not restricted. When the aspect ratio increases, it means that the nanowires are elongated. Longer nanowires compose a denser network or network-like structure leading to a better long-lasting antimicrobial effect. The nanowires preferably have an aspect ratio of more than 20 and less than 1000, and more preferably more than 20 and less than 500, uniformly distributed in the substrate, but the invention is not limited thereto. The optimal aspect ratio of the nanowire is a range of 200 to 500.

The “network-like structure” herein refers to the nanowires in the substrate, forming a three-dimensional network analogue for the metal ions to move on the linked or adjacent nanowires. The phrase “adjacent” means that two or more than two nanowires are unlinked but in a distance of 1 nm to 90 μm. It should be noted that the network-like structure enables the antimicrobial metal ions to move on the nanowires, whether the nanowires are linked or not linked.

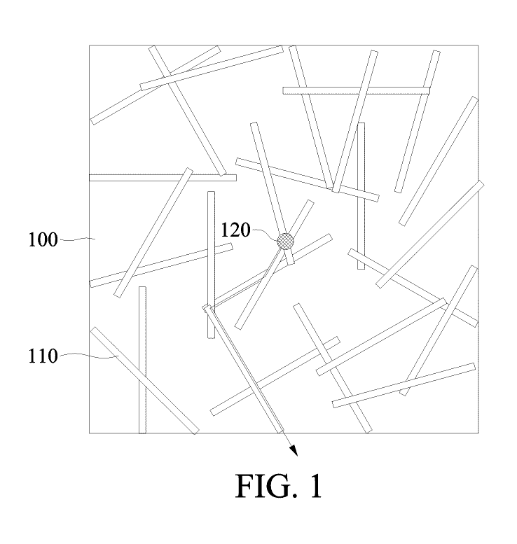

In one embodiment, a plurality of nanowires (110) is distributed in a substrate (100) comprising of a polymer or oligomer, which forms a network-like structure (as shown in FIG. 1). The network-like structure enables the antimicrobial metal ions (120) to move on the different nanowires (110). When the nanowires exposed on the surface of the substrate (100) are attracted by negative electricity on the surface of bacteria, the antimicrobial metal ions (120) in the substrate are released to the surface of the substrate through the network-like structure to inhibit or kill bacteria. Therefore, the network-like structure not only stores but also prolongs the release of the antimicrobial metal ions.

The nanowires of the invention can comprised of single or complex materials, including Ag, Fe, Cu, or combinations thereof In one embodiment, the nanowires are formed by a growth of Ag (from reducing AgNO₃) on seeds of Pt or Ag nanoparticles for heterogeneous nucleation (see, Sun Y., et al., Uniform Silver Nanowires Synthesis by Reducing AgNO₃ with Ethylene Glycol in the Presence of Seeds and Poly(Vinyl Pyrrolidone), Chem. Mater, (2002) 14, 4736-4745.). In other embodiments, the nanowires are formed by growing Cu or Fe on seeds of Ag nanoparticles. Different seeds may be used according to requirements, and the invention is not limited thereto.

One embodiment of the invention uses nanowires with a core-shell structure. The core includes polyacrylonitrile, silicon dioxide, Ag, Cu, or combinations thereof, but the invention is not limited thereto. The shell includes Ag, Fe, Cu or combinations thereof. In one embodiment, the nanowires are comprised of polyacrylonitrile as a core and Ag as a shell. In one embodiment, the nanowires are comprised of silicon dioxide as a core and Ag as a shell. In other embodiments, the nanowires are comprised of Cu as a core and Ag as a shell. In one embodiment, the nanowires are synthesized by a electroless plating method for growing Ag on Ag nanoparticles serving as seeds formed by UV photoreduction on the surface of polyacrylonitrile nanofibers (see, Song, et al., Synthesis of Polyacrylonitrile/Ag Core-Shell Nanowire By An Improved Electroless Plating Method, Materials Letters, 62 (2008), p. 2681-2684.).

In one embodiment of the invention, the nanowires include nanotubes. The nanotubes herein comprise Ag, Fe, Cu, or combinations thereof. In one embodiment, the Ag nanotubes are synthesized by the absorption of Ag nanoparticles at the surface of a functionalized silica rod or polymer latexes as template, followed by removal of the template by a chemical etching process (see, Park, et al., Fabrication of Silver Nanotubes Using Functionalized Silica Rod as Templates, Materials Chemistry and Physics, 87 (2004), 301-310.).

The nanowires or nanotubes herein can be functionally modified by polyhydroxyl compounds. The polyhydroxyl compounds form chemical bonds with the surfaces of the nanowires or nanotubes, which cause the nanowires or nanotubes to increase aspect ratios in a uniform state. The “uniform state” herein refers to each nanowire or nanotube having a difference of lengths in the range of ±20%.

The hydroxyl compounds of the invention include water-soluble polymers, such as polyols, polyamides, polyesters, polyalkylene glycols, polyhydroxyalkanes, polyalkadienes, heteroaliphatic polyols, saturated alicyclic polyols, aromatic polyols, saturated heteroalicyclic polyols, heteroaromatic polyols, or combinations thereof, but the invention is not limited thereto. More specifically, the hydroxyl compounds include polyoxyethylene, polyoxypropylene, ethylene oxide-terminated polypropylene glycols and triols, polybutanediol, polydialkylsiloxane diols, hydroxyl-terminated polyesters, hydroxyl-terminated polylactones, polycaprolactone polyols, 1,2-ethylene glycol, 1,2-propylene glycol, 3-chloro-1,2-propylene glycol, 1,3-propylene glycol, 1,3-butanediol, 1,4-butanediol, 2-methyl-1,3-propanediol, 2,2-dimethyl-1,3-propanediol (neopentylglycol), 2-ethyl-1,3-propanediol, 2,2-diethyl-1,3-propanediol, 1,5-pentanediol, 2-ethyl-1,3-pentanediol, 2,2,4-trimethyl-1,3-pentanediol, 3-methyl-1,5-pentanediol, 1,2-, 1,5- and 1,6-hexanediol, bis(hydroxymethyl)cyclohexane, 1,8-octanediol, bicycle-octanediol, 1,10-decanediol, tricycle-decanediol, norbornanediol, 1,18-dihydroxyoctadecane, polyethylene glycol, glycerin, trimethylolethane, trimethylolpropane, 2-ethyl-2-(hydroxymethyl)-1,3-propanediol, 1,2,6-hexanetriol, pentaerythritol, quinitol, mannitol, sorbitol, diethylene glycol, methylene glycol, tetraethylene glycol, tetramethylene glycol, dipropylene glycol, diisopropylene glycol, tripropylene glycol, 1,11-(3,6-dioxaundecane)diol, 1,14-(3,6,9,12-tetraoxatetradecane)diol, 1,8-(3,6-dioxa-2,5,8-trimethyloctane)diol, 1,14-(5,10-dioxatetradecane)diol, castor oil, 2-butyne-1,4-diol, N,N-bis(hydroxyethyl)benzamide, 4,4′-bis(hydroxymethyl)diphenylsulfone, 1,4-benzenedimethanol, 1,3-bis(2-hydroxyethyoxy)benzene, 1,2-, 1,3-, and 1,4-resorcinol, 1,6-, 2,6-, 2,5- and 2,7-dihydroxynaphthalene, 2,2′- and 4,4′-biphenol, 1,8-dihydroxybiphenyl, 2,4-dihydroxy-6-methyl-pyrimidine, 4,6-dihydroxypyrimidine, 3,6-dihydroxypyridazine, bisphenol A, 4,4′-ethylidenebisphenol, 4,4′-isopropylidenebis(2,6-dimethylphenol), bis(4-hydroxyphenyl)methane, 1,1-bis(4-hydroxyphenyl)-1-phenylethane (bisphenol C), 1,4-bis(2-hydroxyethyl)piperazine, bis(4-hydroxyphenyl)ether, polyvinylpyrrolidone, heteroaliphatic polyols, saturated alicyclic polyols, aromatic polyols, saturated heteroalicyclic polyols, heteroaromatic polyols, or combinations or mixtures thereof, but the invention is not limited thereto. In one embodiment, the polyhydroxyl compounds are preferably polyethylene, polyvinylpyrrolidone (PVP), and/or polyethylene glycol (PEG).

The polymer or oligomer in the invention serves as substrates to form films and to uniformly distribute the nanowires for a network-like structure.

The polymer or oligomer of the invention includes organic polymers, such as polyacetals; polyamides; polyimides; poly(amide-imides); polyolefins; polyesters; polyols; epoxy resins; amino resins; synthetic rubbers; silicon-containing polymers; polysulfides; fluoropolymers, such as copolymers of fluoro-olefine and hydrocarbon olefin, amorphous fluorocarbon polymers or copolymers; or combinations thereof. Specifically, the polymer or oligomer includes phenolics, Novolac, polystyrene, polyvinyltoluene, polyvinylxylene, silicone-epoxy resin, polyetherimide, polypropylene, polymethylpentene, cyclic olefins, polyphenylene, polyphenylethers, polymethacrylate, polyacrylate, polyacrylonitrile, polyethylene terephthalate (PET), polyester naphthalate, polycarbonate, polyurethane (PU), polyacetates, polynorbonenes, polysulfones, polysilsesquioxanes, polysilanes, silicon-siloxane, polydimethylsiloxane (PDMS), acrylonitrile-butadiene-styrene copolymer (ABS), cellulosics, polyvinylchloride (PVC), polyvinylpyrrolidone (PVP), polyethylene glycol (PEG), polyvinyl alcohol (PVA), ethylene propylene rubber (EPR), Styrene-butadiene rubber (SBR), ethylene propylene diene rubber (EPDM), polyvinylidene fluoride, polytetrafluoroethylene (TFE), or polyhexafluoropropylene, but the invention is not limited thereto. In one embodiment, the polymer or oligomer is preferably polyvinyl alcohol (PVA), polyvinylpyrrolidone (PVP), polyethylene glycol (PEG), polydimethylsiloxane (PDMS), polyvinyl butyral (PVB), ethanol (EtOH), or combinations thereof.

In the composition of the invention, the nanowires have a volume percentage of more than 0.1% (also shown as “v/v %” below) based on the polymer or oligomer used. Generally speaking, the greater the amount of nanowires present in the substrate, the better the antimicrobial effect is. In addition, the denser the network-like structure in the substrate is, the longer the antimicrobial effect is. However, for uniform distribution in the substrate, the nanowires are preferably 0.1 v/v % to 10 v/v % based on the polymer or oligomer used. The amount of the nanowires can also be adjusted according to application, such as in coatings or sprays.

The “antimicrobial” herein refers to killing of viruses, bacteria and funguses, or inhibition of growth or activity thereof.

The “long-lasting” herein refers to the amount of time that the composition of the invention has statistically significant antimicrobial effects for at least 20 days, and preferably more than 30 days after implementation.

Additives may be added to the composition of the invention, such as plasticizers, film-forming agents, thinners, stabilizers or the like. The composition can form films in a short period of time through molds, scratching, spin-coating, spraying or the like. The amount of the additives may be adjusted by one skilled in the art according to application, manufacturing process or the like. In one embodiment, the composition has a plasticizer or film-forming agent in a weight percentage of more than 0.01% (also shown as “wt %” below).

The films formed by the composition of the invention can be attached on solid substrates, for example, ceramic tiles, cements, glasses, woods, plastics, or the like, to form an antimicrobial film on the surface of the solid substrate. In addition, the film can be directly removed after use.

### EXAMPLE 1

### Preparation of Ag Nanowires

Ag nanowires were manufactured following the method disclosed in Sun et a., Uniform Silver Nanowires Synthesis By Reducing AgNO₃ With Ethylene Glycol In The Presence Of Seeds And Poly(vinyl pyrrolidone), Chem. Mater. 2002, 14, 4736-4745, herein incorporated by reference.

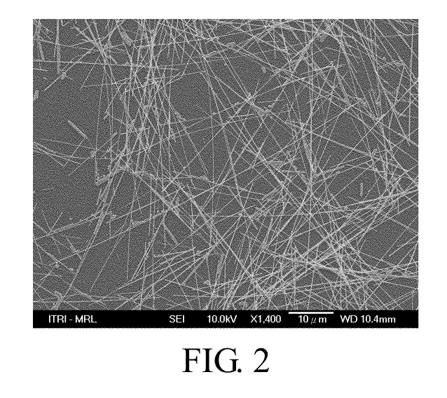

First, 0.5 ml of platinum chloride (PtCl₂, 99.99%) was added to anhydrous ethylene glycol (EG, 99.8%), forming 1.5×10⁻⁴ M of a PtCl₂ solution. The PtCl₂ solution was then added to 5 ml of EG and heated at about 160□. After 4 minutes, 2.5 ml of an AgNO₃ solution (0.12M, in EG) and 5 ml of a polyvinylpyrrolidone (PVP, Mw˜55,000) solution (0.36M, in EG) were added dropwise to the hot solution over a period of 6 min. The reaction mixture was stirred at about 160□ until all AgNO₃ had been completely reduced. The reaction mixture was diluted with acetone (5× by volume) and centrifuged at 2000 rpm for 20 min. The supernatant was removed. The centrifugation procedure was repeated several times until the supernatant became colorless. The Ag nanowires with a diameter of 30-40 nm and a length of 20-50 μm were obtained, as shown in FIG. 2.

### EXAMPLE 2

### Preparation of the Composition Containing Ag Nanowires and the Films Thereof

First, 70 ml of de-ionized water was heated to 150° C. 20 g of polyethylene alcohol (PVA) powders was added to the hot de-ionized water, forming a PVA solution. The Ag nanowires formed in Example 1 were respectively added to the PVA solution with the formulations as listed in Table 3. Each of the PVA solutions was thoroughly mixed to form a composition with Ag nanowires. Then, 1 wt % of a plasticizer (glycerol: ethylene glycol=1:3) was added to each composition and stirred 20 min. After cooling, each composition was poured into a mold to form a film.

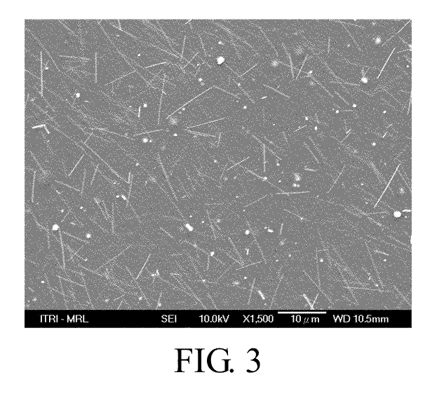

The composition of formulation 1 is shown in FIG. 3 by using a Scan Electron Microscope (SEM) (1400×). Ag nanowires were uniformly distributed in the polymer and formed a network-like structure.

TABLE 3

| | PVA | d.i. water | Ag nanowires | Plasticizer |
|---|---|---|---|---|
| Formulation 1 | 20 g | 70 ml | 0.62 v/v % | 1 wt % |
| Formulation 2 | 20 g | 70 ml | 0.79 v/v % | 1 wt % |
| Formulation 3 | 20 g | 70 ml | 0.96 v/v % | 1 wt % |

### EXAMPLE 3

### Preparation of the Composition Containing Ag Nanowires and the Removed Films Thereof

According to the formulations listed in Table 4, 5 g of polyvinyl butyral (PVB) was dissolved in ethanol (EtOH). 0.62 v/v % of Ag nanowires 2 ml and 0.1 ml or 0.4 ml of ethylene glycol monobutyl ether (EGBE) were added to the EtOH solution. The mixture was poured into a sprayer and sprayed out on a glass plate. Formation of a removable antibacterial film occurred after 5 min.

TABLE 4

| | | | Ag nanowires | |
|---|---|---|---|---|
| | PVB | EtOH | (0.62 v/v %) | EGBE |
| Formula A | 5 g | 45 g | 2 ml | 0.1 ml |
| Formula B | 5 g | 45 g | 2 ml | 0.4 ml |

### COMPARATIVE EXAMPLE 1

A PVA composition was formed according to the process of example 2, but the Ag nanowires were replaced by 0.83 v/v % of Ag nanoparticles. The composition was then poured to a mold forming a film.

### COMPARATIVE EXAMPLE 2

A PVA composition was formed according to the process of example 2 but no Ag nanowires were added. The composition was then formed into a film by molds.

### EXAMPLE 4

### Antimicrobial Tests

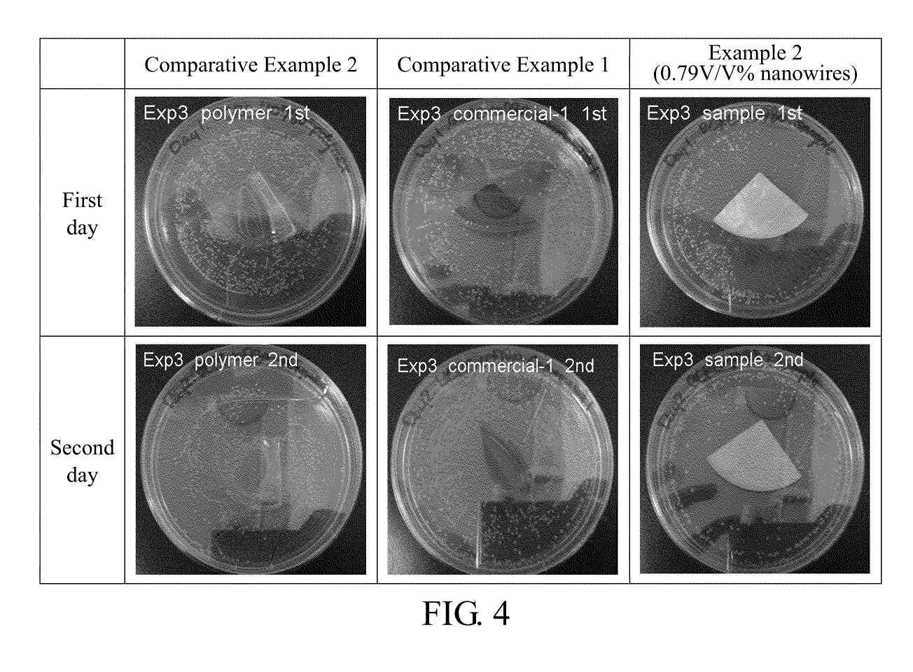

Each of the films of comparative examples 1 and 2 and example 2 (containing 0.79 v/v % of Ag nanowires) was respectively put in three culture mediums. The films and mediums were all plated with Staphylococcus aureus and then cultured 24 hours under 37° C., CO₂. The results following the first day are shown in FIG. 4.

Each film was then individually shifted to new culture mediums also plated with S. aureus and cultured for another 24 hours. The results following the second day are also shown in FIG. 4.

As shown in FIG. 4, the film of Comparative Example 2 was covered by bacteria colonies, showing that PVA itself has no antimicrobial effect. For the film containing Ag nanoparticles of Comparative Example 1, a few bacteria colonies formed on the first day, indicating that the film had antimicrobial effects. Additionally, bacteria colonies formed surrounding the film, indicating that the antibacterial effect expanded out in the surrounding areas of the film. The expanded area is called the “antimicrobial area” or “transparent area”.

The film containing Ag nanowires of Example 2 and its surrounding areas also showed antibacterial effects on the first day, with the antimicrobial area being larger than that of the Comparative example 1 (FIG. 4). Thus, the film of Example 2 not only inhibited the growth of bacteria on the film but also released Ag ions to kill surrounding area bacteria. Thus, the film containing Ag nanowires showed better antimicrobial ability.

The films were tested again on new mediums on the second day. The film containing Ag nanoparticles of Comparative Example 1 exhibited a smaller antimicrobial area, indicating that the antimicrobial effect decreased. However, the film of Example 2 on the second day still had a few bacteria colonies on the film, wherein a similar antimicrobial area was observed when compared to the first day. The results showed that Ag nanowires in the substrate showed prolonged antimicrobial ability than the Ag nanoparticles.

### EXAMPLE 5

### Long-Lasting Antimicrobial Test

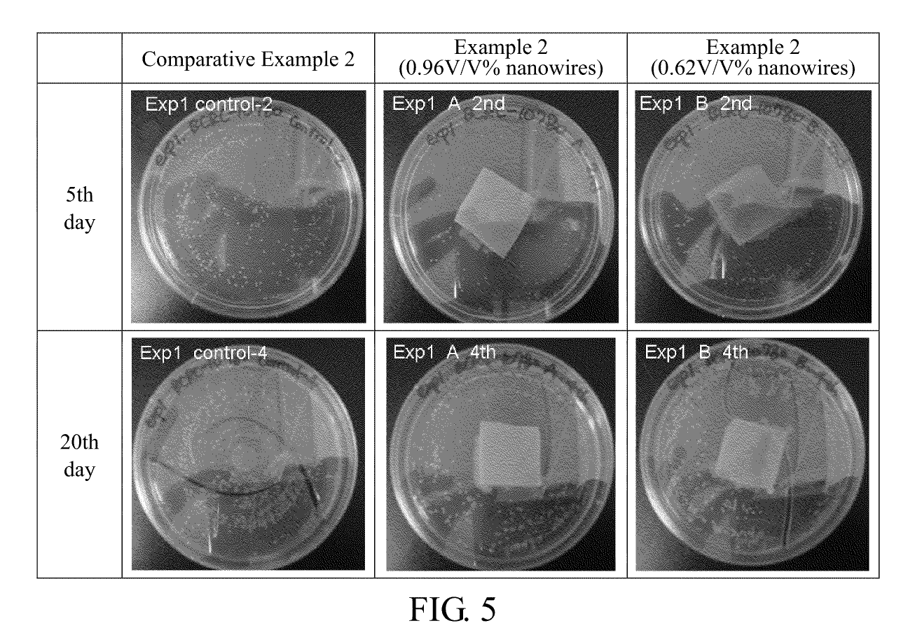

Each of the films containing 0 v/v % (Comparative Example 2), 0.62 v/v % and 0.96 v/v % of Ag nanowires (Example 2) were respectively put in three culture mediums under the same culture condition of Example 4 but cultured for 5 days. The films were shifted to new mediums, coated with S. aureus and cultured for another 5 days. The process was repeated twice. The distribution of the bacteria colonies on the 5th day and 20th day were recorded, as shown in FIG. 5.

Again, PVA itself had no antimicrobial effect (Comparative Example 2). On the 5th day, the films of Example 2, containing 0.62 v/v % and 0.96 v/v % of Ag nanowires, did not have bacteria colonies formed on the films The surrounding areas of the films showed few bacteria colonies. Also, the antimicrobial areas changed minimally after 10 days, and the colonies in the antimicrobial area failed to grow in a new medium (data not shown).

After 20 days, there were clear antimicrobial areas both for the films containing 0.62 v/v % and 0.96 v/v % of Ag nanowires, while the film containing a higher concentration of Ag nanowires (0.96 v/v %) showed a clearer and larger antibacterial area. The result exhibited that the composition of the invention possesses a long-lasting antimicrobial effect and the effect relates to the quantity of the nanowires of the invention used.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A long-lasting anti-microbial composition, comprising one or more polymer or oligomer; and
a plurality of nanowires distributed in the polymer or oligomer,
wherein the nanowires have an aspect ratio of more than 20 and form a network-like structure.

2. The composition as claimed in claim 1, wherein the nanowires have an aspect ratio of 200-500.

3. The composition as claimed in claim 1, wherein the nanowires comprise Ag, Fe, Cu, or combinations thereof.

4. The composition as claimed in claim 1, wherein the nanowires comprise a core-shell structure, in which the core comprises polyacrylonitrile, silicon dioxide, Ag, Cu, or combinations thereof, and the shell comprises Ag, Fe, Cu, or combinations thereof.

5. The composition as claimed in claim 1, wherein the nanowires comprise nanotubes.

6. The composition as claimed in claim 1, wherein the nanowires comprise 0.1% to 10% volume percentage of the composition.

7. The composition as claimed in claim 1, wherein the nanowires are functionalized with polyhydroxyl compounds.

8. The composition as claimed in claim 7, wherein the polyhydroxyl compounds comprise polyols, polyamides, polyester, polyalkylene glycols, polyhydroxyalkanes, polyalkadienes, heteroaliphatic polyols, saturated alicyclic polyols, aromatic polyols, saturated heteroalicyclic polyols, heteroaromatic polyols, or combinations thereof.

9. The composition as claimed in claim 8, wherein the polyhydroxyl compounds comprise polyvinylpyrrolidone (PVP), polyethylene glycol (PEG), or combinations thereof.

10. The composition as claimed in claim 1, wherein the polymer or oligomer comprises organic polymers, fluoropolymers, or combinations thereof.

11. The composition as claimed in claim 10, wherein the polymer or oligomer comprises polyvinyl alcohol (PVA), polyvinylpyrrolidone (PVP), polyethylene glycol (PEG), polydimethylsiloxane (PDMS), polyvinyl butyral (PVB), or combinations thereof.

12. An anti-microbial film, comprising the long-lasting anti-microbial composition as claimed in claim 1.

13. An anti-microbial spray, comprising the long-lasting anti-microbial composition as claimed in claim 1.
